(19) United States
(12) Patent Application Publication
(10) Pub. No.: US 2016/0161730 A1
(43) Pub. Date: Jun. 9, 2016

(54) MEASUREMENT DEVICE USING OPTICAL INTERFEROMETRY AND MEASUREMENT METHOD USING OPTICAL INTERFEROMETRY

(71) Applicant: FUJITSU LIMITED, Kawasaki-shi (JP)

(72) Inventor: Makoto Nakamura, Kawasaki (JP)

(73) Assignee: FUJITSU LIMITED, Kawasaki-shi (JP)

(21) Appl. No.: 15/017,013

(22) Filed: Feb. 5, 2016

Related U.S. Application Data
(63) Continuation of application No. PCT/JP2014/069690, filed on Jul. 25, 2014.

(30) Foreign Application Priority Data
Aug. 15, 2013 (JP) 2013-168921

(51) Int. Cl. G02B 21/26; G01B 9/02; G02B 21/36; G01B 11/14

(52) U.S. Cl. CPC G02B 21/26; G01B 11/14; G01B 9/02; G02B 21/362

(57) ABSTRACT

Provided are a measurement device using optical interferometry and a measurement method using optical interferometry that accurately measure the depth of a recess having a high aspect ratio. The measurement device is provided with a sensor for measuring distance using optical interferometry, an optical microscope having an optical axis in a fixed relationship with the optical axis of the sensor, a sample stage on which a sample to be measured is placed, a means for maintaining a fixed distance between a sensor head end of the sensor and a surface of the sample during measurement, and a tilt adjustment means for tilting the surface of the sample or the optical axis of the sensor so as to maximize the intensity of the sensor light reflected from the surface of the sample or the interference intensity of the sensor light reflected from the surface of the sample and the sensor head end.

### CROSS-REFERENCE TO RELATED APPLICATION

This application is a continuation of International Application No. PCT/JP2014/69690, filed on Jul. 25, 2014, now pending, herein incorporated by reference. Further, this application is based upon and claims the benefit of priority from the prior Japanese Patent Application No. 2013-168921, filed on Aug. 15, 2013 entire contents of which are incorporated herein by reference.

### FIELD

The present invention relates to a measurement device using optical interferometry and to a measurement method using optical interferometry, for instance, a measurement device using optical interferometry and a measurement method using optical interferometry, for measuring precisely the depth of TSV (Through Silicon Via) via holes that are provided in semiconductor substrates.

### BACKGROUND

Three-dimensional integration technologies in identical or different devices have attracted attention in recent years accompanying ever increasing integration and functionality in semiconductor devices. The use of TSVs (Through Silicon Vias) has been studied as one approach for realizing such three-dimensional integration of semiconductor devices.

Measuring the depth of etched holes for through-electrodes that are opened in a silicon substrate is an important issue in the process of making TSVs. This arises, for instance, from the need for stopping thinning of the substrate, leaving several μm of silicon in the immediate vicinity of TSVs, during grinding and thinning from a back surface, with a view to preventing device contamination by copper of electrode materials in a via middle process.

In order to stop mechanical grinding in the immediately vicinity of TSVs, it is important to control, with high precision, the in-plane distribution of the depth of reactive ion etching (RIE). Herein TSV depth formed by RIE needs to be measured accurately to that end.

Such depth measurement of etched holes involves currently radiating infrared light through a back surface of the silicon substrate, as illustrated in FIG. 17, and measuring an interference waveform arising from optical path differences between:

(a) reflected light from the back surface of the silicon substrate;
(b) reflected light from the TSV bottom; and
(c) reflected light from the silicon substrate surface.

In an ordinary method,

i) the TSV depth . . . optical path difference between (b) and (c); and
ii) the thickness of the silicon substrate . . . optical path difference between (a) and (c)
are calculated on the basis of a power spectrum obtained through Fourier transformation of the measured interference waveforms. Mass-produced equipment from several manufactures are commercially available herein.

In such commercially available measurement methods, TSV depth is calculated on the basis of an optical path difference in silicon, assuming the refractive index of silicon as constant. Accordingly, measurement errors arise in cases where layers of refractive index different from that of silicon are present within the silicon or on the surface thereof.

For instance, in cases where:

(1) a high-concentration dopant injection layer is present;
(2) some layer (insulating film or the like) is present on the back surface (ordinarily, a hard mask of SiO₂, SiN or the like is used when TSV holes are opened by RIE, and hence a film of the foregoing is present on the back surface as well);
(3) a substrate is used in which differences in dopant concentration and/or oxygen concentration are significant; or
(4) a substrate of SOI structure is used;
TSV depth cannot be measured correctly. Further, probe light that can be used is limited to infrared light, which passes through silicon. In this case, though, strict optical axis adjustment is not necessary, which is advantageous.

### CITATION LIST

### Patent Literature

Patent literature 1: Japanese Laid-open Patent Publication No. 2008-076379

### SUMMARY

As illustrated in FIG. 18, thus, it suffices to cause light to be incident from the sample surface, and to utilize interference of light reflected from the surface and the TSV bottom in order to solve the above problem. Specifically,

a. a probe is irradiated simultaneously onto a TSV portion and a flat portion, and interference of the reflected light is utilized;
b. there are used interference (d) of reflected light from a sensor tip and a sample surface flat portion, and interference (e) of reflected light from the sensor tip and the TSV bottom.

An optical path difference between the sample surface and an air layer in the TSV portion is used for measurement in such a method. Accordingly, this method is advantageous in being completely independent from the physical properties of the sample. The light that can be used herein, moreover, need not take into consideration absorption in the silicon substrate. This is advantageous therefore in that the light is not limited to infrared light.

The method in a) above is widely used as a method for measuring surface irregularities by optical interference (see, for instance, Patent literature 1), but no measurement examples of deep holes with high aspect ratios, such as TSVs, have been reported for such methods. Conventionally, a structure in this case involves a spectroscope being provided coaxially with an optical microscope, and the method is not used as a method for measuring the distance between the sample and a reference surface that is provided on a sensor head.

The optical microscope and the probe optical axis can be integrated together in this method, but on the other hand interference waveforms cannot be obtained ordinarily unless probe light is radiated onto both the TSV portion and the flat portion, which is problematic. Further, the distance between the sample surface and the sensor cannot be determined accurately, which is accordingly problematic on account of the associated difficulty in assessing absolute values of light intensity.

The method in b), by contrast, is commercially available in the form of sensors that measure a distance between a sensor head 44 and a sample on the basis of an optical path difference between reflected (reference) light from a reference reflective surface 47 at the leading end of the sensor head 44 and reflected light 46 from the surface of a measurement object 45, as illustrated in FIG. 19. The reference symbols 41, 42, 43, 48 to 52 in the figure denote respectively a light source such as a superluminescent diode (SLD), sensor light, a polarization maintaining fiber, interference light, a spectroscope, a diffraction grating, a CCD camera and a waveform analysis unit. As illustrated in FIG. 19, reflected light d from the sample surface and reflected light e from the TSV bottom are measured using such a commercially available sensor, and the TSV depth can be worked out as a result. In this case, the probe may be irradiated onto both the TSV portion and the sample surface at one time or independently.

In this method there is measured the distance between the sensor head and the workpiece, and hence measurements may be performed by causing the probe to strike either one or both of the TSV portion and the flat portion; on the other hand, offset with the optical microscope and axis adjustment are indispensable.

FIG. 20 is an interference spectrum obtained through actual measurement of a TSV region having φ20 μm and a depth of 200 μm, using a commercially available sensor. The probe diameter is about φ40 μm, and the peaks correspond to the following, in the order below:

P₁: interference spectrum of reflected light from the surface and reflected light from the TSV bottom;
P₂: interference spectrum of reflected light from a sensor end and the surface;
P₃: interference spectrum of reflected light from the sensor end and the TSV bottom.
Specifically, the value of (P₃−P₂) and P₁ correspond to the TSV depth.

In this method, however, the sensor has to be disposed at an optimal position (in the normal direction of the sample) for light from the sensor that reaches the TSV bottom and is reflected thereon. The alignment technology involved herein is important, and will therefore be explained with reference to FIG. 21A to FIG. 22B. FIGS. 21A and 21B are sets of explanatory diagrams of the arrangement relationship between a sensor head and a sample, where FIG. 21A is an explanatory diagram of an instance where the optical axis of the sensor runs along the normal direction of the sample, and FIG. 21B is an explanatory diagram of an instance where the optical axis of the sensor is oblique with respect to the normal direction of the sample.

In a case where the probe does not reach the TSV bottom when the depth of the TSV is large, the light reflected at the TSV bottom does not reach the sensor, and measurement is accordingly difficult, when there is no sensor head in the sample normal direction, as a comparison between FIG. 21A and FIG. 21B reveals.

FIGS. 22A and 22B are sets of explanatory diagrams of the arrangement relationship between a sensor head and a sample in an instance where sensor light is radiated onto a flat surface of the sample, where FIG. 22A is an explanatory diagram of an instance where the optical axis of the sensor runs along the normal direction of the sample, and FIG. 22B is an explanatory diagram of an instance where the optical axis of the sensor is oblique with respect to the normal direction of the sample.

As a comparison between FIGS. 22A and 22B reveals, the intensity of reflected light from the sample becomes weaker when there is no sensor head in the sample normal direction. Accordingly, the reflected light intensity that is measured varies depending on the tilt of the sample, even when the distance between the sample and the sensor is kept at a desired value. A problem arises as a result in that the absolute value and peak shape of reflected light cannot be assessed, and sample surface states cannot be compared quantitatively.

According to an aspect of the embodiments, a measurement device using optical interferometry, comprising:

a sensor that measures a distance by optical interferometry;
an optical microscope, the optical axis of which is in a predetermined relationship with the optical axis of the sensor;
a sample stage on which a sample to be measured is placed;
a unit that keeps a predetermined distance between a sensor head end of the sensor and a surface of the sample during measurement; and
a tilt adjustment unit that tilts one of the surface of the sample and the optical axis of the sensor so that the intensity of the sensor light reflected from the surface of the sample or interference intensity of the sensor light reflected from the surface of the sample and the sensor head end exhibits maximized.

In another aspect disclosed herein there is provided a measurement method using optical interferometry, the method including: radiating sensor light, from a sensor having an optical axis being in a predetermined relationship with an optical axis of an optical microscope, onto a sample to be measured, in a state where a distance between a sensor head end of the sensor and a surface of the sample is kept constant, while observing, by the optical microscope, the surface of the sample in a state where a predetermined distance to the surface of the sample is kept; tilting one of the surface of the sample and the optical axis of the sensor so that the intensity of the sensor light reflected from the surface of the sample or interference intensity of the sensor light reflected from the surface of the sample and the sensor head end exhibits maximized; and measuring an interference waveform of reflected light of the sensor light from the sensor head end, in a state where the intensity of the sensor light reflected from the surface of the sample or interference intensity of the sensor light reflected from the surface of the sample and the sensor head end exhibits maximized, and determining, by optical interferometry, a distance between a portion to be measured in the sample and the sensor head end.

The measurement device using optical interferometry and the measurement method using optical interferometry disclosed herein allow measuring the depth of high-aspect ratio recesses with good precision.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a conceptual configuration diagram of a measurement device using optical interferometry of an embodiment of the present invention;

FIG. 2 is a conceptual configuration diagram of a measurement device using optical interferometry of Embodiment 1 of the present invention;

FIG. 3 is a wavelength distribution diagram of a light source that is used for measurements;

FIGS. 4A and 4B are sets of explanatory diagrams of interference waveforms of reflected light from a sensor head and a sample surface;

FIG. 5 is a conceptual configuration diagram of a measurement device using optical interferometry of Embodiment 2 of the present invention;

FIGS. 6A and 6B are sets of explanatory diagrams of a tilting mechanism of a tilting mechanism of a sample stage;

FIG. 7 is a conceptual configuration diagram of a measurement device using optical interferometry of Embodiment 3 of the present invention;

FIGS. 8A and 8B are sets of explanatory diagrams of a first axis adjustment chip that is utilized in a measurement method using optical interferometry of Embodiment 4 of the present invention;

FIGS. 9A-9D are sets of explanatory diagrams of a fabrication process of a first axis adjustment chip;

FIGS. 10A and 10B are sets of explanatory diagrams of a second axis adjustment chip that is utilized in a measurement method using optical interferometry of Embodiment 4 of the present invention;

FIGS. 11A and 11B are sets of explanatory diagrams of a third axis adjustment chip that is utilized in a measurement method using optical interferometry of Embodiment 4 of the present invention;

FIGS. 12A-12E are sets of explanatory diagrams up to halfway a fabrication process of a third axis adjustment chip;

FIGS. 12F-12J are sets of explanatory diagrams of a fabrication process, from FIG. 12E onwards, of a third axis adjustment chip;

FIGS. 13A and 13B are sets of explanatory diagrams of a fourth axis adjustment chip that is utilized in a measurement method using optical interferometry of Embodiment 4 of the present invention;

FIGS. 14A and 14B are sets of explanatory diagrams of a fifth axis adjustment chip that is utilized in a measurement method using optical interferometry of Embodiment 4 of the present invention;

FIGS. 15A-15D are sets of explanatory diagrams of a measurement method using optical interferometry of Embodiment 4 of the present invention;

FIGS. 16A and 16B are sets of explanatory diagrams of a measurement method using optical interferometry of Embodiment 5 of the present invention;

FIG. 17 is an explanatory diagram of a method for measuring the depth of etched holes;

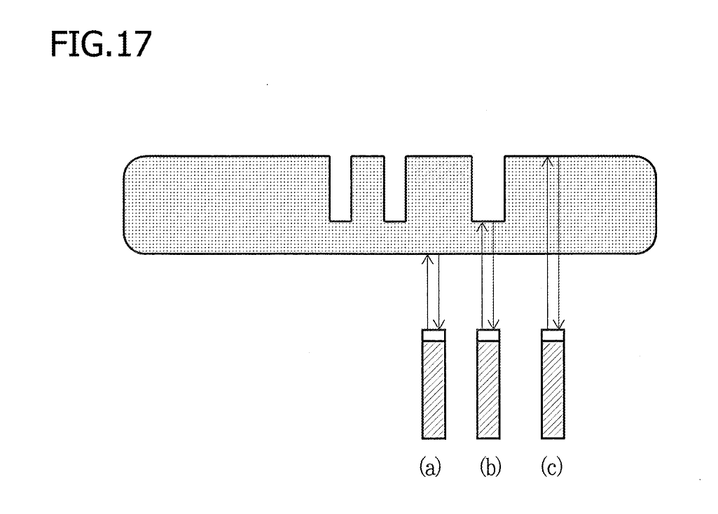

FIG. 18 is an explanatory diagram of an instance of measurement from a surface;

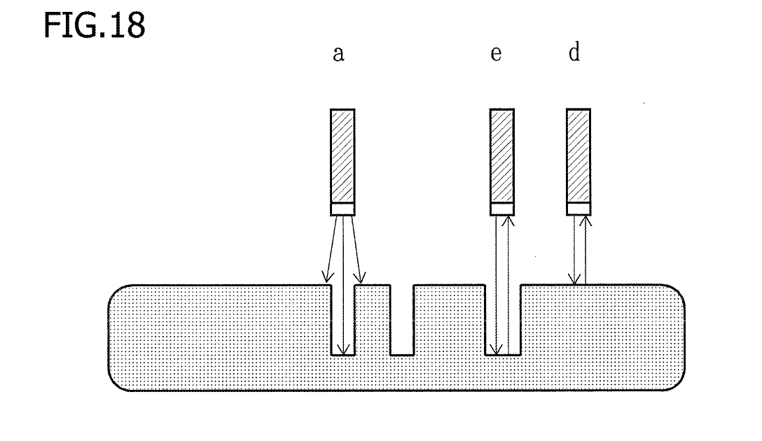

FIG. 19 is a configuration explanatory diagram of an example of a commercially available sensor;

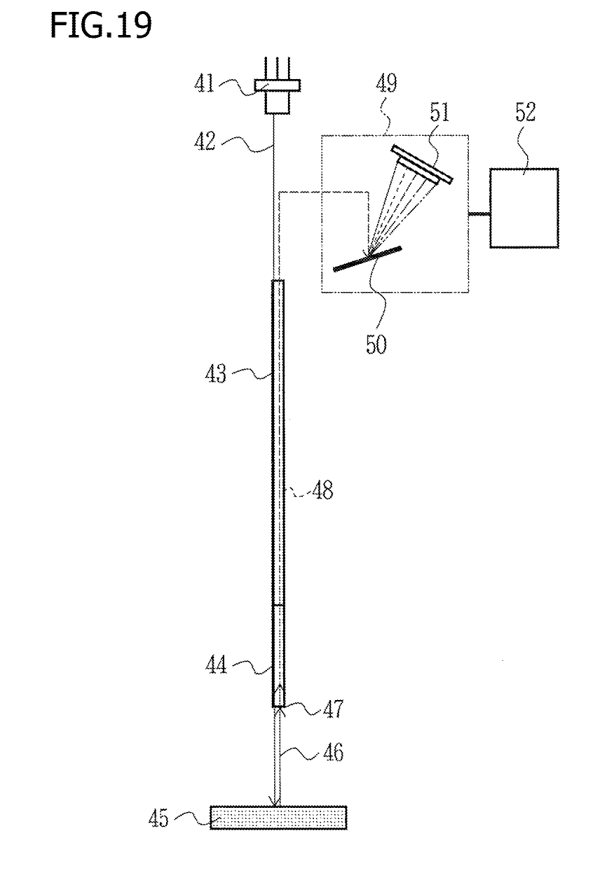

FIG. 20 is an explanatory diagram of interference spectra obtained through measurement of a TSV region;

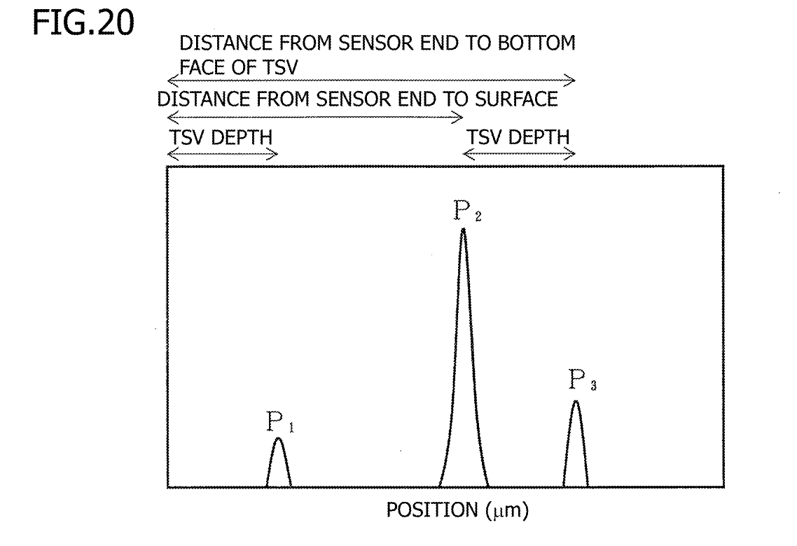

FIGS. 21A and 21B are sets of explanatory diagrams of an arrangement relationship between a sensor head and a sample; and

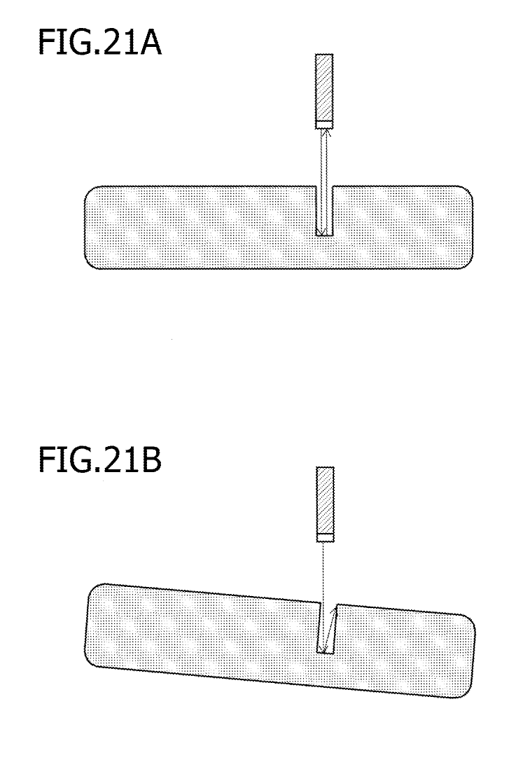

FIGS. 22A and 22B are sets of explanatory diagrams of the arrangement relationship between a sensor head and a sample in an instance where sensor light is radiated onto a flat surface of the sample.

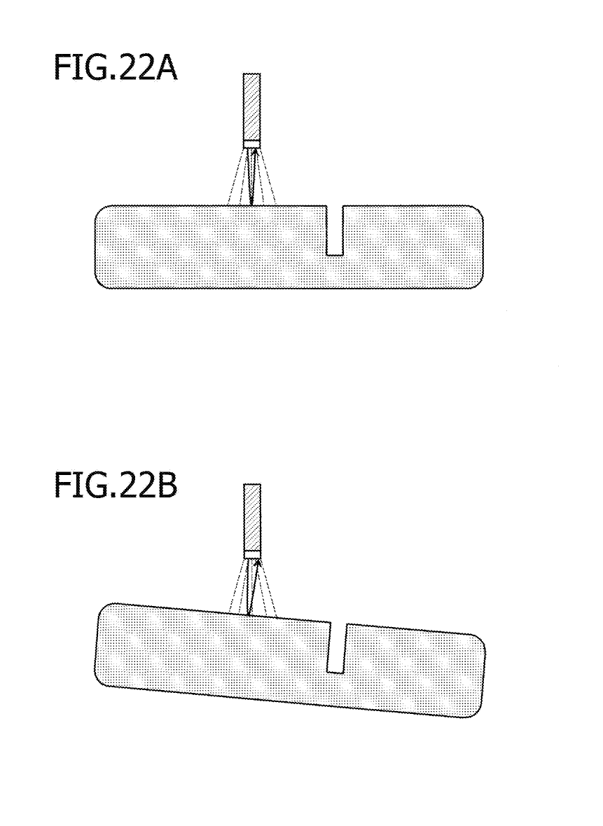

### DESCRIPTION OF EMBODIMENTS

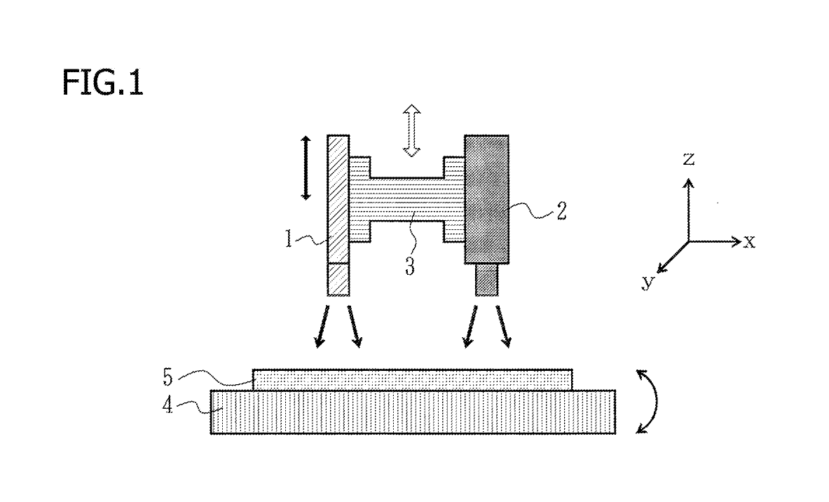

A measurement device and a measurement method using optical interferometry of an embodiment of the present invention will be explained next with reference to FIG. 1. FIG. 1 is a conceptual configuration diagram of a measurement device using optical interferometry of an embodiment of the present invention. Herein there are provided a sensor 1 that measures distance by optical interferometry, an optical microscope 2 having a predetermined relationship with the optical axis of the sensor 1, and a sample stage 4 having a sample to be measured 5 placed thereon. There are further provided a unit which maintains a constant distance between a sensor head end of the sensor 1 and the surface of the sample 5 during measurement, and a tilt adjustment unit which tilts one from among the surface of the sample 5 and the optical axis of the sensor 1 in such a manner that the interference intensity of reflected light from the surface of the sample 5 is maximized.

At least part of the optical system of the sensor 1 may be set to share the optical system of the optical microscope 2. Alternatively, the optical system of the sensor 1 may be set to be an optical system separate from the optical system of the optical microscope 2. In a case where the optical system of the sensor 1 is set to be an optical system separate from the optical system of the optical microscope 2, a mechanism is provided that stores offset coordinates for observing the same field of view as that of the optical microscope 2.

In a case where the optical system of the sensor 1 is set to be an optical system separate from the optical system of the optical microscope 2, a shared support member 3 may be provided that fixes the sensor 1 and the optical microscope 2 while being capable of simultaneously operating to vary a distance from the sample 5. In this case, a mechanism that independently tilts the optical axis alone is provided in the optical microscope 2, while in the sensor 1 there is provided a driving mechanism that allows adjusting independently the distance between the sample 5 and the tilt adjustment mechanism that tilts independently the optical axis.

In a case where, alternatively, the shared support member 3 is provided that fixes the sensor 1 and the optical microscope 2 while being capable of simultaneously operating to vary a distance from the sample, a tilt adjustment mechanism that allows adjusting the tilt independently may be provided in the sample stage 4. In this case, a driving mechanism may be provided that allows adjusting independently the distance between the sample 5 and the tilt adjustment mechanism that tilts independently the optical axis, on the sensor 1 side alone.

In measurements using such a measurement device:

Σ₁: Sensor light is radiated onto the sample 5 to be measured, in a state where the predetermined distance between the sensor head end of the sensor 1 and the surface of the sample 5 is kept, while observing, via the optical microscope 2, the surface of the sample 5, in a state where the predetermined distance to the surface of the sample 5 is kept.
Σ₂: Next, one from among the surface of the sample 5 and the optical axis of the sensor 1 is tilted in such a manner that there is maximized the intensity of the sensor light reflected from the surface of the sample 5 or the interference intensity of the sensor light reflected from the surface of the sample 5 and the sensor head end.
Σ₃: Next, there is determined the distance between a portion to be measured and the sensor head end, by optical interferometry, through measurement of an interference waveform of the reflected light from the sensor head end, in a state where the intensity of the sensor light reflected from the surface of the sample 5 or the interference intensity of the sensor light reflected from the surface of the sample 5 and the sensor head end has been maximized.

A semiconductor substrate such as a silicon wafer is a typical instance of the sample in this case, and a via hole for a through-via provided in the semiconductor substrate is a typical instance of the portion to be measured.

In order to evaluate the roughness of the bottom face of a via hole for a through-via it suffices to set the probe diameter of the sensor light to be equal to or smaller than ¾ of the via diameter of the via hole. To evaluate the roughness of a via bottom in the sample 5, alternatively, a comparison may be performed that involves radiating the sensor light to the via hole and to a flat surface of the sample 5 having no via hole provided therein.

In this case the degree of flatness of the bottom face of the via hole and the surface roughness of the surface of the sample in the vicinity of the via hole can be calculated by cross-comparing and analyzing the intensity and shape of a power spectrum that is obtained through Fourier transformation of the measured interference waveform.

In an embodiment of the present invention, the depth of, for instance, deep via holes having an aspect ratio of 10 or higher can be measured, using a commercially available sensor, by relying on a sensor alignment method and by devising a mechanism. Herein measurements are carried out with the distance between the sensor and the workpiece being kept precisely fixed. As a result, this allows comparing absolute values of interference waveform intensity, to evaluate via diameter, evaluate the surface area of the flat surface of the via bottom, and evaluate the roughness of the sample surface and of the via bottom.

A high-aspect ratio hole actually formed is used in the method described above, except at the wafer edge. Accordingly, signals from the hole bottom may fail to be obtained and adjustments be increasingly difficult, as the hole diameter decreases, on account of deviation in the tilt axis of the sensor and on account of the flatness of the bottom.

In order to solve the above problem, therefore, an axis adjustment dedicated member is used that has an axis adjustment structure including a protrusion or a recess having a planar area that lies within a range of ±10% of the planar area of a portion to be measured, in axis adjustment.

For instance, an axis adjustment dedicated member having a plurality of protrusions of dissimilar planar area may be used as the axis adjustment dedicate member. Specifically, protrusions of identical height but dissimilar planar area may be arrayed at a pitch equal to or greater than 100 μm.

As the axis adjustment dedicated member there may be alternatively used an axis adjustment dedicated member having a plurality of recesses of aspect ratio equal to or smaller than 1 and having dissimilar planar areas. Specifically, recesses of identical depth but dissimilar planar area may be arrayed at a pitch equal to or greater than 100 μm.

As the axis adjustment dedicated member there may be alternatively used an axis adjustment dedicated member having a stepped protrusion being a superposition of concentric cylindrical protrusions of sequentially decreasing size, or an axis adjustment dedicated member having a stepped recess in which concentric cylindrical recesses are delved in decreasing order of size. An axis adjustment dedicated member may also be used that has a stepped recess in which concentric cylindrical recesses are delved in decreasing order of size, with a protrusion being provided at the center of the stepped recess.

The surface of the protrusion is flat at the atomic level, and hence an axis adjustment dedicated member provided with a protrusion is preferable herein. Knife edges of X-direction or Y-direction are preferably provided in the periphery of the axis adjustment dedicated member.

In a case where the optical axes of the optical microscope and the sensor are adjusted using such an axis adjustment dedicated member:

a. the tilt of the sample or of the optical microscope is adjusted in such a manner that a state is brought about in which the side walls of the protrusions or recesses are not visible or so that the surface area of the protrusions or the surface area of the recesses is maximal;
b. next, in a state where the distance up to the surface of the protrusions or the bottom face of the recesses has been set to a specified value, the optical axis of the sensor is adjusted, in such a manner that the interference peak is maximized, and the amount of offset with respect to the optical microscope is finely adjusted.

### Embodiment 1

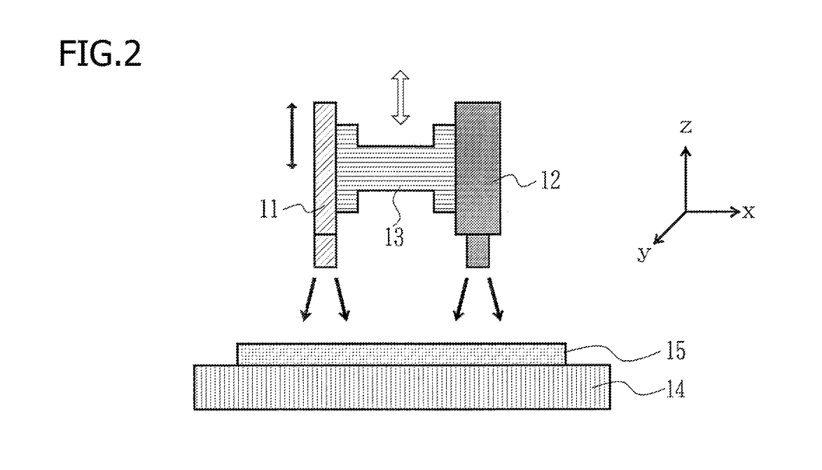

A measurement device and a measurement method using optical interferometry of Embodiment 1 of the present invention will be explained next with reference to FIG. 2 to FIG. 4B. FIG. 2 is a conceptual configuration diagram of a measurement device using optical interferometry of Embodiment 1 of the present invention. Provided herein are a shared support block 13 that fixes both a sensor 11 that measures a distance by optical interferometry and a optical microscope 12, and a sample stage 14 on which a sample is placed. As the sensor 11 there is used SI-F10 (product model, by Keyence Corporation) equipped with a mechanism that allows the sensor 11 to move independently in the z-axis direction, and that renders the optical axis tiltable in the x-axis direction and the y-axis direction. The optical microscope 12 is tiltable independently in the x-axis direction and the y-axis direction, and is moved in the z-axis direction by the shared support block 13. The sample stage 14 is provided with a vacuum chuck mechanism and has a sample 15, such as a semiconductor wafer, placed/fixed thereon. In this case, the sample stage need not be provided with a tilting mechanism.

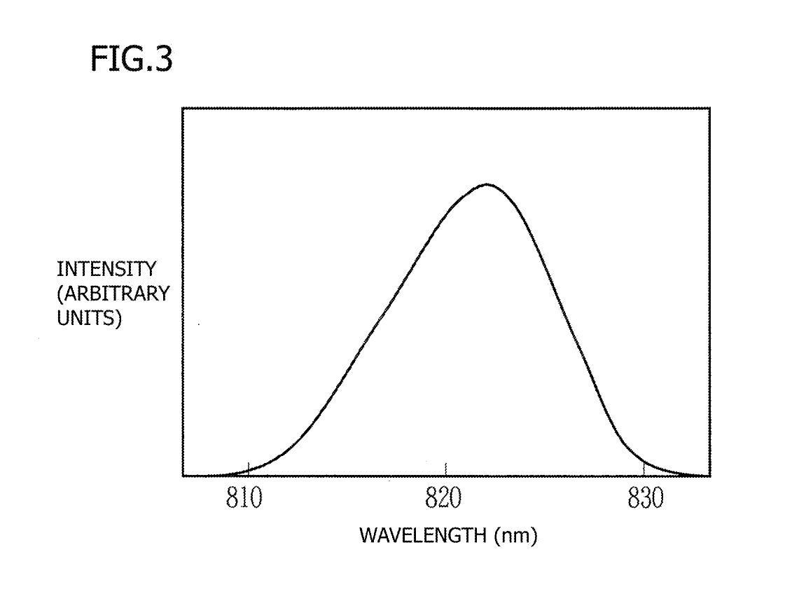

FIG. 3 is a wavelength distribution diagram of a light source that is used for measurements. An infrared SLD having a wavelength peak at 820 nm in the near-infrared region is used herein as the light source. The light is not limited to infrared light, since light is not caused to pass through the within the silicon substrate, as in conventional instances.

The measurement method will be explained next.

S₁: To perform tilt axis adjustment, focusing is carried out through displacement of the shared support block 13 while a pattern for axis alignment (for instance, a φ20 μm TSV), is watched with a camera of the optical microscope 12, so as so as to bring about normal incidence. The tilt axis may be adjusted so that the optical microscope 12 adopts the sample normal direction, in such a manner that the via bottom becomes visible or that via diameter is maximized.
S₂: The coordinate offset between the sensor 11 and the optical microscope 12 is worked out next. As a sample for alignment, for instance a sample is prepared that has an L-shaped groove pattern or cross groove pattern formed on the surface of the sample; x-axis and y-axis adjustment is then carried out using this L-shaped groove pattern or cross groove pattern.
S₃: Next, the sample stage 14 is moved in such a manner that the sensor 11 and the optical microscope 12 correspond to a pattern-free flat region.
S₄: Next, the z-axis in which the sensor 11 is independent is adjusted in such a manner that a distance exhibiting a peak from interference of reflected light from the sensor end and the surface of the sample 15 takes on a predetermined value. A distance of for instance 11.0 mm is set herein. When the distance between the sensor 11 and the sample 15 takes on a desired value, the optical microscope 12 is adjusted to be brought into focus.
S₅: Next, the tilt of the sensor 11 is finely adjusted so that the peak from the interference of the reflected light from the sensor end and the surface of the sample 15 is maximized. In most cases this fine adjustment is smaller than 0.5°. Alternatively, the tilt of the sensor 11 is finely adjusted so that the peak from interference of reflected light from the sensor end and the bottom face of the TSV is maximized.
S₆: Steps S₂ to S₅ are repeated thereafter, to adjust the tilt axis and offset (x, y) of the sensor at a position of maximum peak intensity, with a desired value of the distance between the sensor 11 and the sample 15.

As a result of the above adjustment, the optical axis of the sensor 11 and the vertical direction of the sample 15 are identical at the focus position of the optical microscope 12, and hence the actual measurement can begin next.

S₇: The shared support block 13 is moved, with the sample 15 for measurement placed/fixed on the sample stage 14, to bring the optical microscope 12 into focus.
S₈: The sensor 11 is moved to the position of the TSV that is formed in the sample 15, and the shared support block 13 is finely adjusted by being displaced in the z-direction in such a manner that the distance between the sensor 11 and the surface of the sample 15 takes on a predetermined value. The depth of the TSV is measured thereafter.

In a case where the sensor tip has a reference surface, the probe diameter may be set to a size that includes the flat portion and the via diameter to be measured, for instance a diameter of 40 μm, or to a size sufficiently smaller than the via diameter, for instance smaller than the via diameter.

In a case where the probe diameter was set to a size that includes the flat portion and the via diameter to be measured,

(1) via diameter could be estimated on the basis of peak intensity; and
(2) surface roughness could be estimated on the basis of the spread of interference peak waveforms.

On the other hand, in a case where the probe diameter was set to be smaller than the via diameter,

(3) the surface area of the flat surface of the via bottom could be evaluated on the basis of peak intensity; and
(4) the surface roughness of the via bottom could be estimated on the basis of the spread of interference peak waveforms.

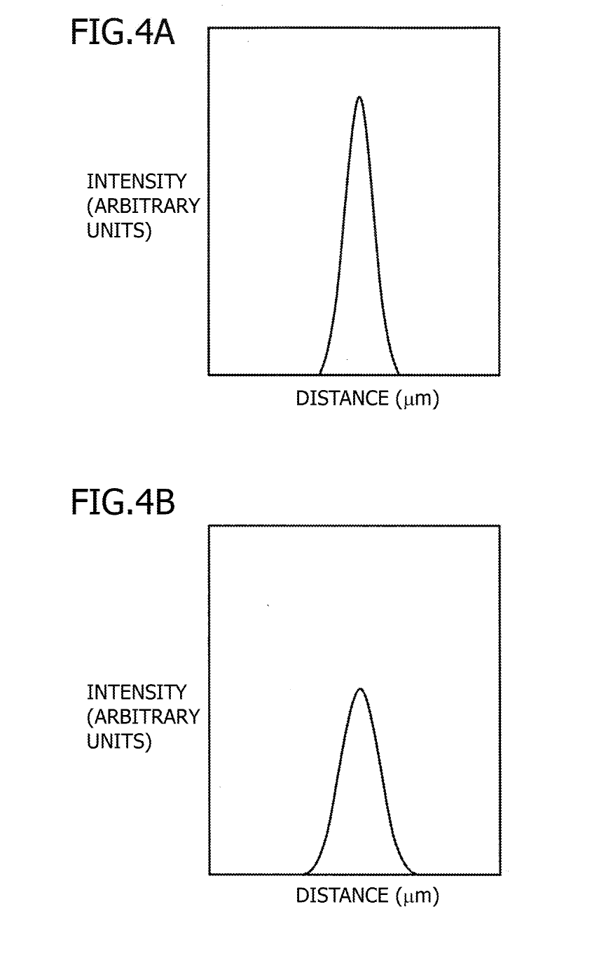

FIGS. 4 A and 4B is a set of explanatory diagrams of interference waveforms of reflected light from a sensor head and a sample surface, where FIG. 4A is an interference waveform of a flat-surface sample, and FIG. 4B is an interference waveform of a rough-surface sample. As FIG. 4A illustrates, the interference waveform of a flat-surface sample is a sharp waveform the peak whereof exhibits a high intensity. By contrast, the interference waveform of a rough-surface sample exhibits a wider peak half width and lower peak intensity, as illustrated in FIG. 4B. The surface roughness of the sample and the roughness of the via bottom can be evaluated by measuring beforehand the shape of the interference waveform that is obtained from such a flat surface.

In Embodiment 1 of the present invention, thus, via holes of high aspect ratio can be measured using a commercially available sensor, for instance a sensor SI-F10 (product model, by Keyence Corporation), by relying on a sensor alignment method and by devising a mechanism such as a shared support block. Vias having a via diameter of φ3.2 μm and a depth of 34 μm could be measured herein. It was also possible to measure via holes having an aspect ratio of 10 or higher, for instance via holes having a via diameter of 5 μm and a depth of 54 μm, and via holes having a via diameter of 10 μm and a depth of 162 μm. Results were thus obtained that could not have been anticipated in conventional measurement technologies using commercially available sensors.

### Embodiment 2

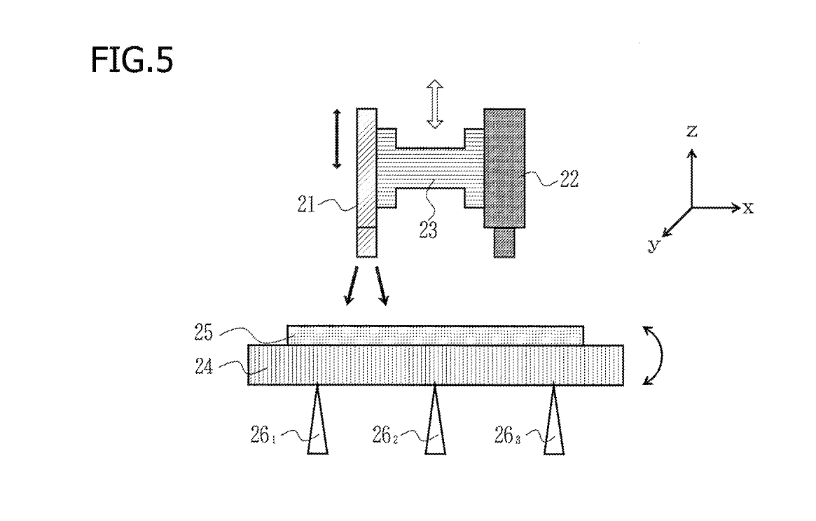

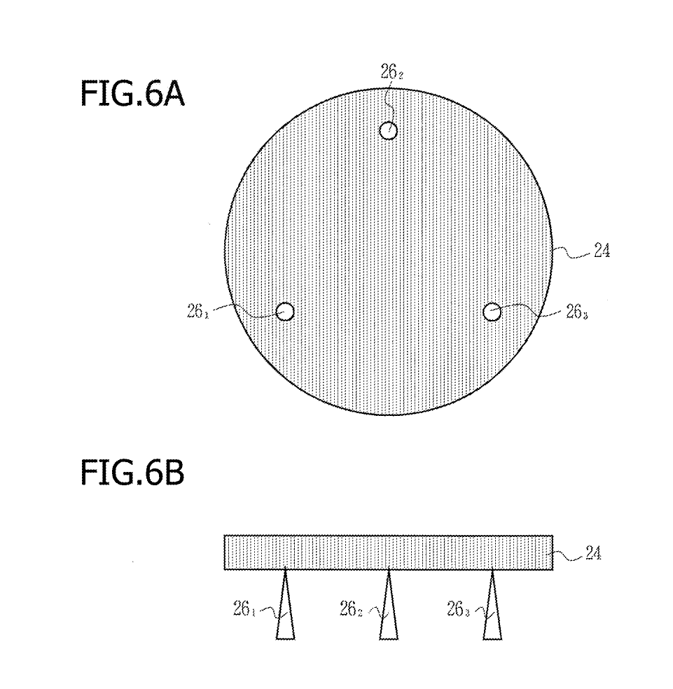

A measurement device and a measurement method using optical interferometry of Embodiment 2 of the present invention will be explained next with reference to FIG. 5 and FIG. 6B. FIG. 5 is a conceptual configuration diagram of a measurement device using optical interferometry of Embodiment 2 of the present invention. Provided herein are a shared support block 23 that fixes both a sensor 21 that measures a distance by optical interferometry and a optical microscope 22, and a sample stage 24 on which a sample is placed. As the sensor 21 there is used SI-F10 (product model, by Keyence Corporation) equipped with a mechanism that allows the sensor 21 to move independently in the z-axis direction, and that renders the optical axis tiltable in the x-axis direction and the y-axis direction. The optical microscope 22 is adjusted in the z-axis direction by the shared support block 23. No tilt adjustment mechanism in the x-axis direction or the y-axis direction is provided in the optical microscope 22. The sample stage 24 is provided with a vacuum chuck mechanism and a tilting mechanism. A sample 25 such as a semiconductor wafer or the like is placed/fixed on the sample stage 24, and the tilt of the sample 25 in the normal direction is adjusted. In Embodiment 2 as well, a light source is used that has the spectral characteristic illustrated in FIG. 2.

FIGS. 6A and 6B is a set of explanatory diagrams of a tilting mechanism of a tilting mechanism of a sample stage, where FIG. 6A is a bottom-view diagram, and FIG. 6B is a side-view diagram. As illustrated in the figures, three pins 26₁ to 26₃ are provided at the bottom of the sample stage 24. The sample stage 24 can easily be tilted stably in any direction as a result of the up and down movement of the three pins 26₁ to 26₃.

The measurement method is explained next.

s₁: Firstly, focusing is carried out by moving the shared support block 23 while a pattern for axis alignment is watched (for instance, a φ20 μm TSV) with a camera of the optical microscope 22 so as to bring about normal incidence, and the tilt axis of the sample stage 24 is adjusted, so as to bring about normal incidence. Adjustment may be performed so that the optical microscope 12 adopts the sample normal direction, in such a manner that the via bottom becomes visible or that via diameter is maximized.
s₂: Coordinate offset between the sensor 21 and the optical microscope 22 is worked out next. For instance, a sample having an L-shaped groove pattern or cross groove pattern formed on the surface is prepared as a standard sample for alignment, and x-axis and y-axis adjustment is then carried out using the L-shaped groove pattern or cross groove pattern, as in Embodiment 1.
s₃: Next, the sample stage 24 is moved in such a manner that the sensor 21 and the optical microscope 22 correspond to a pattern-free flat region.
s₄: Next, the z-axis in which the sensor 21 is independent, is adjusted in such a manner that a distance exhibiting a peak from interference of reflected light from the sensor end and the surface of the sample 25 takes on a predetermined value. A distance of for instance 11.0 mm is set herein. In this case, the optical microscope 22 is adjusted to be brought into focus when the distance between the sensor 21 and the sample 25 takes on a desired value.
s₅: Next, the tilt of the sensor 21 is finely adjusted so that the peak from the interference of the reflected light from the sensor end and the surface of the sample 25 is maximized. In most cases this fine adjustment is smaller than 0.5°. Alternatively, the tilt of the sensor 21 is finely adjusted so that the peak from interference of reflected light from the sensor end and the bottom face of the TSV is maximized.
s₆: Steps s₂ to s₅ are repeated thereafter, to adjust the tilt axis and offset (x, y) of the sensor at a position of maximum peak intensity, with a desired value of the distance between the sensor 21 and the sample 25.

As a result of the above adjustment, the optical axis of the sensor 21 and the vertical direction of the sample 25 are identical at the focus position of the optical microscope 22, and hence the actual measurement can begin next.

s₇: The shared support block 23 is moved, with the sample 25 for measurement placed/fixed on the sample stage 24, to bring the optical microscope 22 into focus.
s₈: The sensor 21 is moved to the position of the TSV that is formed in the sample 25, and the shared support block 24 is finely adjusted by being displaced in the z-direction in such a manner that the distance between the sensor 21 and the surface of the sample 25 takes on a predetermined value. The depth of the TSV is measured thereafter.

In a case where the sensor tip has a reference surface, the probe diameter may be set to a size that includes the flat portion and the via diameter to be measured, for instance a diameter of 40 μm, or to a size sufficiently smaller than the via diameter, for instance ¾ or less of the via diameter, similarly to Embodiment 1.

In a case where the probe diameter was set to a size that includes the flat portion and the via diameter to be measured, as in Embodiment 1,

(1) via diameter could be estimated on the basis of peak intensity; and
(2) surface roughness could be estimated on the basis of the spread of interference peak waveforms.

On the other hand, in a case where the probe diameter was set to be smaller than the via diameter,

(3) the surface area of the flat surface of the via bottom could be evaluated on the basis of peak intensity; and
(4) the surface roughness of the via bottom could be estimated on the basis of the spread of interference peak waveforms.

### Embodiment 3

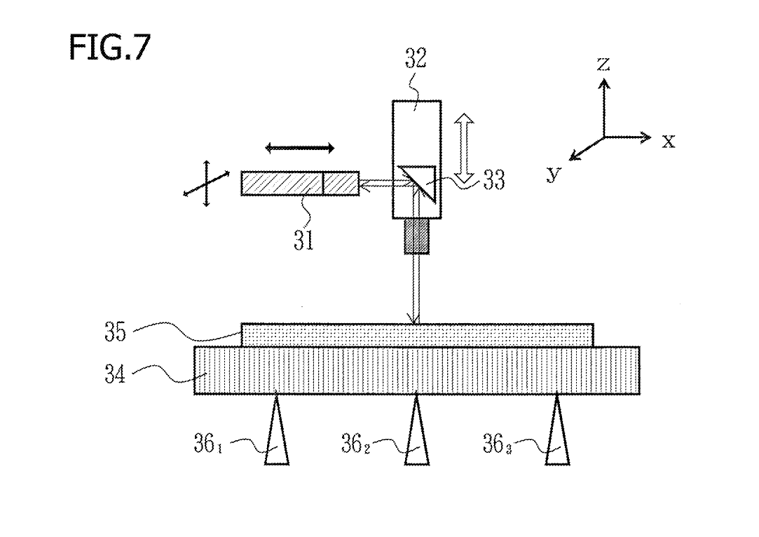

A measurement device and a measurement method using optical interferometry of Embodiment 3 of the present invention will be explained next with reference to FIG. 7. FIG. 7 is a conceptual configuration diagram of a measurement device using optical interferometry of Embodiment 3 of the present invention. Provided herein are an optical microscope 32 having an optical mirror 33 inserted in the optical axis, and a sensor head 31 that shares the optical mirror 33 and is inserted in the optical microscope. A sample stage 34 provided with a vacuum chuck mechanism and a tilting mechanism is also provided, as in Embodiment 2. The x-axis, y-axis and z-axis of the sensor head 31 can operate independently, and the optical microscope 32 operates independently in the sample normal direction. The reference symbols 36₁ to 36₃ in the figure denote pins.

The measurement method is explained next.

σ₁: Firstly, focusing is carried out by tilting the sample stage 34 while a pattern for axis alignment (for instance, a φ20 μm TSV) is watched with a camera of the optical microscope 32, so as to bring about normal incidence. Adjustment may be performed so that the optical microscope 12 adopts the sample normal direction, in such a manner that the via bottom becomes visible or that via diameter is maximized.
σ₂: Next, the x-axis and y-axis of the sensor are adjusted to adjust the latter to the same field of view as that of the optical microscope 32. For instance, a sample having an L-shaped groove pattern or cross groove pattern formed on the surface is prepared as a standard sample for alignment, and x-axis and y-axis adjustment is then carried out using the L-shaped groove pattern or cross groove pattern.
σ₃: Next, the sample stage 34 is moved in such a manner that optical microscope 32 corresponds to a pattern-free flat region.
σ₄: Next, the z-axis, in which the sensor head 31 is independent, is adjusted in such a manner that a distance exhibiting a peak from interference of reflected light from the sensor end and the surface of the sample 35 takes on a predetermined value. A distance of for instance 80 mm is set herein. When the distance between the sensor head 31 and the sample 35 takes on a desired value, the optical microscope 32 is adjusted to be brought into focus.
σ₅: steps σ₂ to σ₄ are repeated, to adjust the optical axis of the optical microscope 32 and the optical axis of the sensor, with a desired value of the distance between the sensor head 31 and the sample 35.

As a result of the above adjustment, the optical axis of the sensor head 31 and the vertical direction of the sample 35 are identical at the focus position of the optical microscope 32, and hence the actual measurement can begin next.

σ₆: In a state where the sample 35 for measurement is placed/fixed on the sample stage 34, a support block, not shown, that supports the optical microscope 32 is moved, to bring the optical microscope 32 into focus.
σ₇: The optical microscope 32 is moved to the position of the TSV that is formed on the sample 35, the z-axis movement mechanism of the optical microscope is moved and finely adjusted in such a manner that the distance between the sensor head 31 and the surface of the sample 35 takes on a predetermined value. The depth of the TSV is measured thereafter.

In a case where the sensor tip has a reference surface, the probe diameter may be set to a size that includes the flat portion and the via diameter to be measured, for instance a diameter of 40 μm. In Embodiment 3, the wavelength of the reference light and the wavelength of the optical microscope are different, and hence it is difficult to reduce the probe diameter. In Embodiment 3:

(1) via diameter could be estimated on the basis of peak intensity; and
(2) surface roughness could be estimated on the basis of the spread of interference peak waveforms.

In Embodiment 3, the optical mirror is shared, and hence the optical axis of the sensor and the optical axis of the optical microscope coincide with each other. Therefore, a measurement step of the amount of offset between the optical axis of the sensor and the optical axis of the optical microscope is unnecessary.

### Embodiment 4

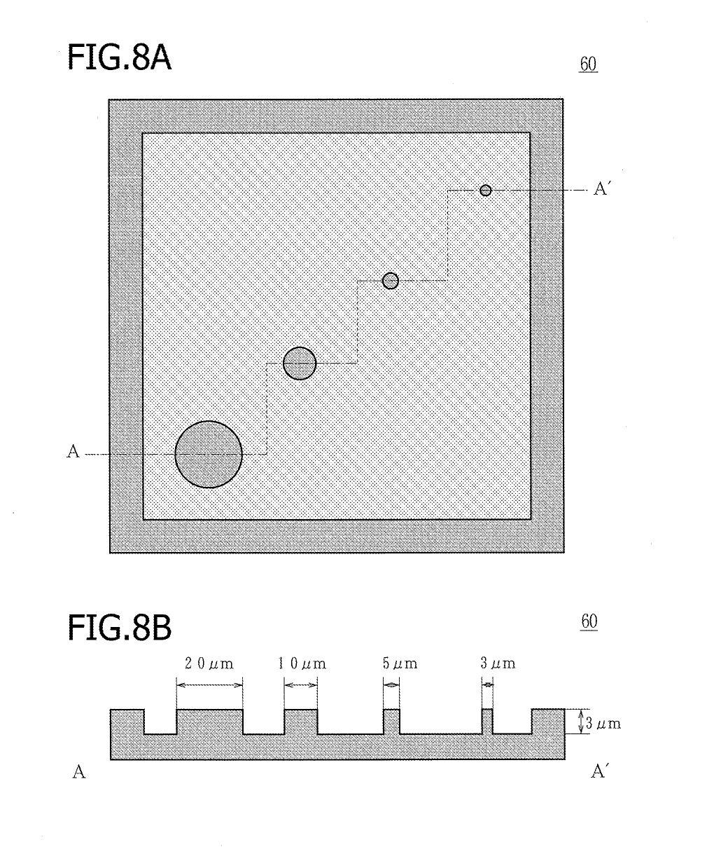

A measurement method using optical interferometry of Embodiment 4 of the present invention will be explained next with reference to FIG. 8A to FIG. 16D. The measurement device of Embodiment 1 or Embodiment 2 is used as the measurement device itself. In Embodiment 4 of the present invention there is used no high-aspect ratio holes actually formed, but an axis adjustment dedicated chip. An axis adjustment chip will be explained first with reference to FIG. 8A to FIG. 15B.

FIGS. 8A and 8B are sets of explanatory diagrams of a first axis adjustment chip that is used in the measurement method using optical interferometry of Embodiment 4 of the present invention, where FIG. 8A is a plan-view diagram, and FIG. 8B is a cross-sectional diagram resulting from connecting the horizontal portions of the dashed line that joins A-A′ in FIG. 8A. A first axis adjustment chip 60 is fabricated out of a single-crystal Si substrate, so that protrusions having a height of 3 μm and diameters of 20 μm, 10 μm, 5 μm and 3 μm are respectively provided at a pitch of 50 μm. Further, X-direction and Y-direction knife edges are provided around the chip.

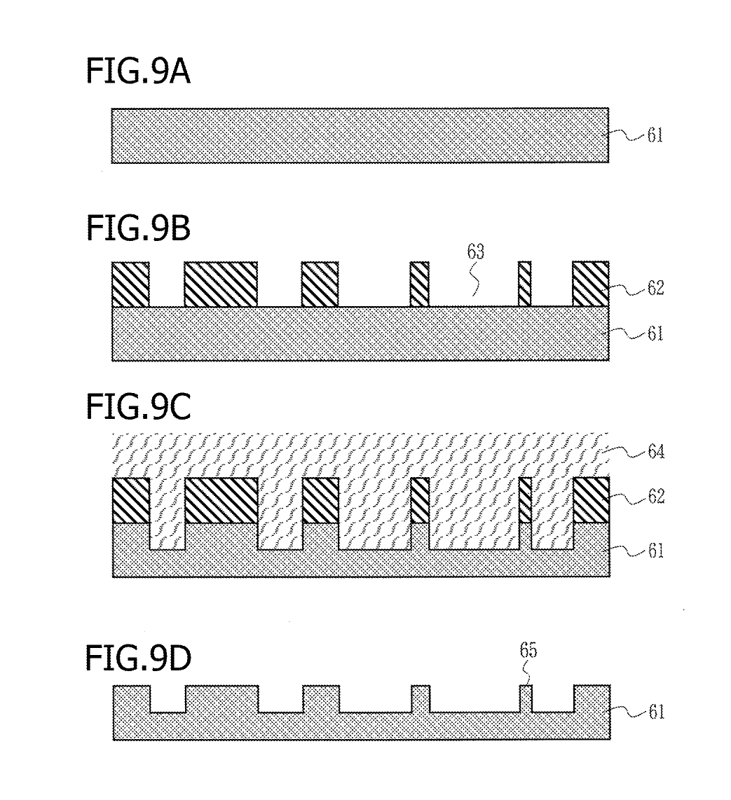

A method for fabricating the first adjustment chip will be explained first with reference to FIGS. 9A to 9D. A single-crystal Si substrate 61 the surface whereof has been planarized to the atomic level is prepared first, as illustrated in FIG. 9A. Next, as illustrated in FIG. 9B a photoresist is applied, exposed and developed, to form thereby a resist mask 62 having circular-pattern openings 63 illustrated in FIGS. 8A and 8B. Next, as illustrated in FIG. 9C, the exposed surface of the single-crystal Si substrate 61 is delved by 3 μm with a fluorocarbon-based etching gas 64, using the resist mask 62 as a mask. Next, as illustrated in FIG. 9D, the resist mask 62 is stripped off, to yield as a result the first axis adjustment chip 60 the cross-sectional shape whereof has protrusions 65 illustrated in FIG. 8B.

In the first axis adjustment chip, the surface of the protrusions 65 serves as an irradiation surface of sensor light. High-precision measurements can be performed herein since the surface is flat at the atomic level.

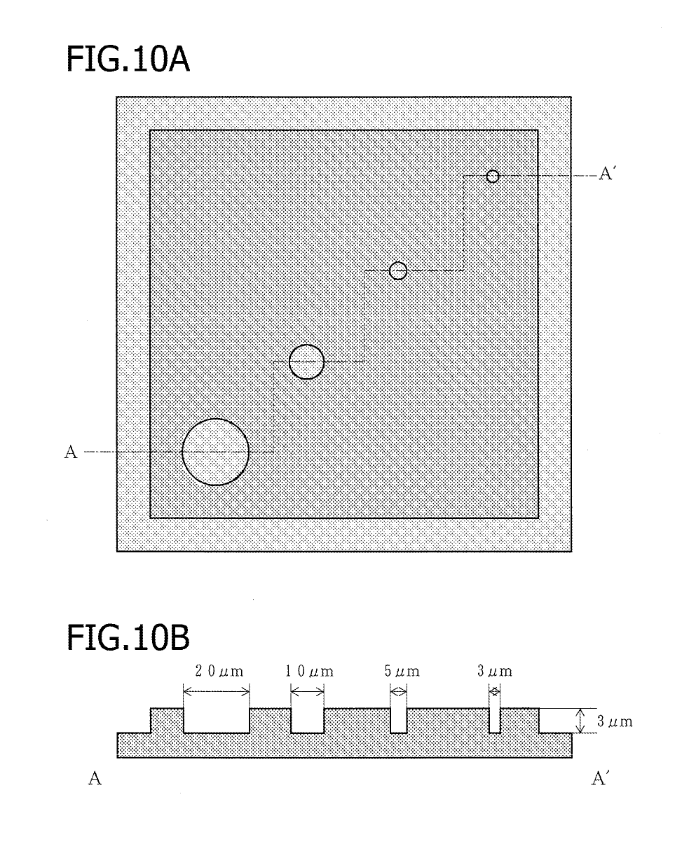

A second axis adjustment chip will be explained next with reference to FIGS. 10A and 10B. FIGS. 10A and 8B are sets of explanatory diagrams of a second axis adjustment chip that is used in the measurement method using optical interferometry of Embodiment 4 of the present invention, where FIG. 10A is a plan-view diagram and FIG. 10B is a cross-sectional diagram in which there are connected the horizontal portions of the dashed line that joins A-A′ in FIG. 10A. The second axis adjustment chip is fabricated out of a single-crystal Si substrate, so that recesses having a depth of 3 μm, and diameters of 20 μm, 10 μm, 5 μm and 3 μm, respectively, are provided at a pitch of 50 μm. Further, X-direction and Y-direction knife edges are provided around the chip. The fabrication process is identical to the fabrication process of the first axis adjustment chip, but herein the protrusion-recess relationship is reversed.

In the second axis adjustment chip, the aspect ratio of the recess having the smallest diameter is set to 1, and the aspect ratios of other recesses are set to be smaller than 1. Therefore, the axis adjustment step is not affected by deviation in the tilt axis of the sensor or by the flatness of the bottom face of the recesses.

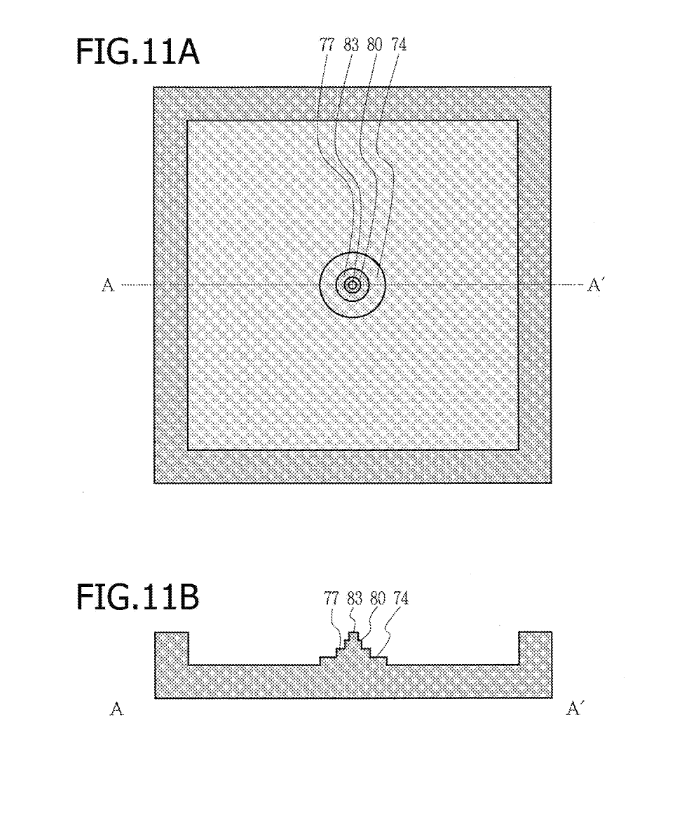

A third axis adjustment chip will be explained next with reference to FIGS. 11A and 11B. FIGS. 11A and 11B are sets of explanatory diagrams of a third axis adjustment chip that is used in the measurement method using optical interferometry of Embodiment 4 of the present invention, where FIG. 11A is a plan-view diagram and FIG. 11B is a cross-sectional diagram in which there are connected the horizontal portions of the dashed line that joins A-A′ in FIG. 11A. The third axis adjustment chip is fabricated out of a single-crystal Si substrate, so that protrusions having diameters of 20 μm, 10 μm, 5 μm and 3 μm are sequentially superposed in the form of concentric cylinders having a thickness of 5 μm. Further, X-direction and Y-direction knife edges are provided around the chip.

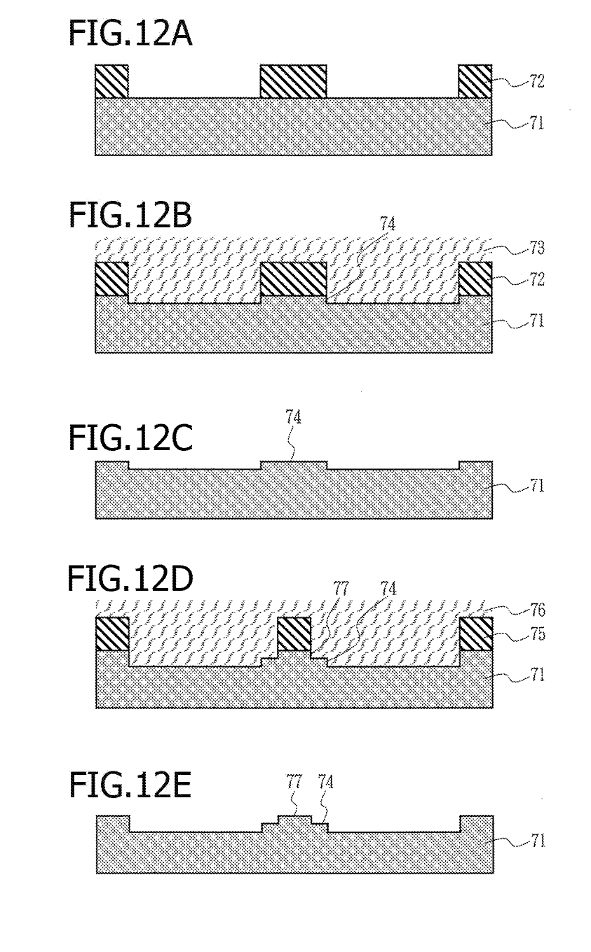

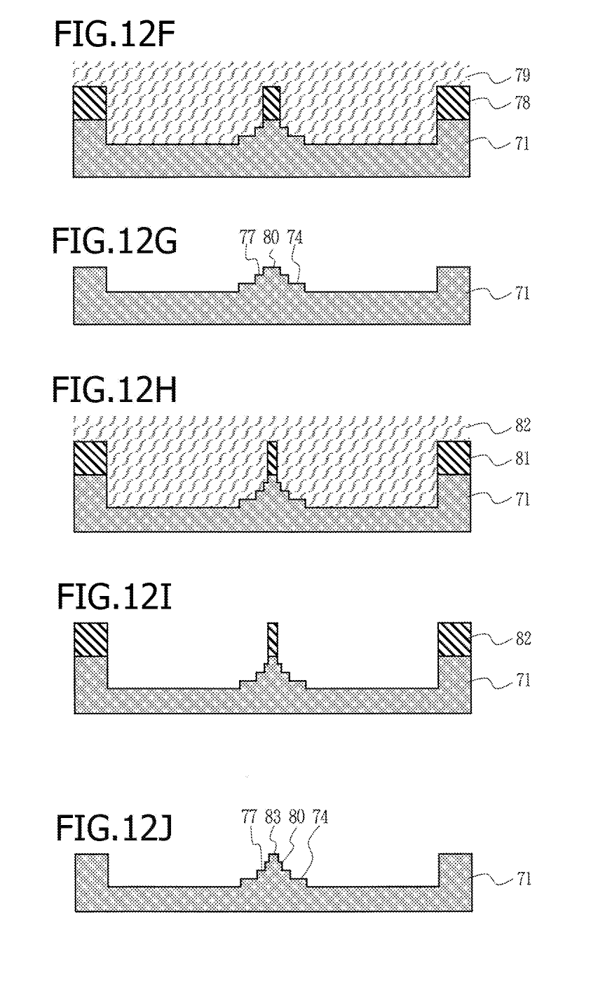

A fabrication process of the third axis adjustment chip will be explained next with reference to FIGS. 12A to 12J. Firstly, as illustrated in FIG. 12A, a single-crystal Si substrate 71 the surface whereof has been planarized to the atomic level is coated with a photoresist, followed by exposure and development, to form thereby a resist mask 72 having a 20 μm-diameter pattern. Next, as illustrated in FIG. 12B, the exposed surface of the single-crystal Si substrate 71 is delved by 5 μm with a fluorocarbon-based etching gas 73, using the resist mask 72 as a mask. Next, as illustrated in FIG. 12C, the resist mask 72 is stripped off, whereupon a first-tier protrusion 74 having a diameter of 20 μm is formed as a result.

Next, as illustrated in FIG. 12D, a photoresist is applied, exposed and developed, to form as a result a resist mask 75 having a 10 μm-diameter pattern concentric with the first-tier protrusion 74. Next, the exposed surface of the single-crystal Si substrate 71 is delved by 5 μm with a fluorocarbon-based etching gas 76, using the resist mask 75 as a mask. Next, as illustrated in FIG. 12E, the resist mask 75 is stripped off, whereupon a second-tier protrusion 77 having a diameter of 10 μm is formed as a result.

Next, as illustrated in FIG. 12F, a photoresist is applied, exposed and developed, to form as a result a resist mask 78 having a 5 μm-diameter pattern concentric with the first-tier protrusion 74. Next, the exposed surface of the single-crystal Si substrate 71 is delved by 5 μm with a fluorocarbon-based etching gas 79, using the resist mask 78 as a mask. Next, as illustrated in FIG. 12G, the resist mask 78 is stripped off, whereupon a third-tier protrusion 80 having a diameter of 5 μm is formed as a result.

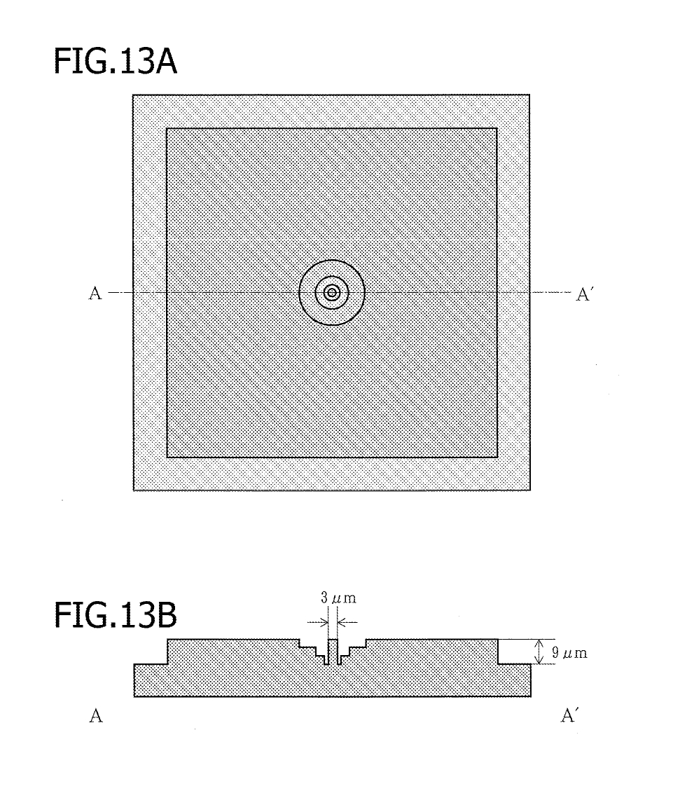

Next, as illustrated in FIG. 12H, a photoresist is applied, exposed and developed, to form as a result a resist mask 81 having a 3 μm-diameter pattern concentric with the first-tier protrusion 74. Next, the exposed surface of the single-crystal Si substrate 71 is delved with a fluorocarbon-based etching gas 82, using the resist mask 81 as a mask. Next, as illustrated in FIG. 12I, etching is stopped at the point in time at which the exposed surface of the single-crystal Si substrate 71 has been delved down by 5 μm. Next, the resist mask 81 is stripped off, as a result of which a protrusion structure is obtained in which the first-tier protrusion 74 having a diameter of 20 μm, the second-tier protrusion 77 having a diameter of 10 μm, the third-tier protrusion 80 having a diameter of 5 μm and the fourth-tier protrusion 83 having a diameter of 3 μm are superposed in this order, as illustrated in FIG. 13J.

In the case of this third axis adjustment chip, reflected light can be obtained from protrusions having different surface areas at one location. When a calibration curve is to be created, therefore, it suffices to perform registration once, which makes the curve creation process simpler.

A fourth axis adjustment chip will be explained next with reference to FIGS. 13A and 13B. FIGS. 13A and 13B is a set of explanatory diagrams of a fourth axis adjustment chip that is used in the measurement method using optical interferometry of Embodiment 4 of the present invention, where FIG. 13A is a plan-view diagram and FIG. 13B is a cross-sectional diagram in which there are connected the horizontal portions of the dashed line that joins A-A′ in FIG. 13A. The fourth axis adjustment chip is fabricated out of a single-crystal Si substrate, to be delved in the form of concentric cylinders, 5 μm deep, having diameters of 20 μm, 10 μm and 5 μm in this order, with a cylindrical protrusion having a height of 9 μm and a diameter of 3 μm being provided at the center. Further, X-direction and Y-direction knife edges are provided around the chip. The fabrication process may involve reversing the protrusion-recess scheme with respect to that of the third axis adjustment chip, and by performing etching with a 3 μm-diameter resist pattern being provided at the center at all times.

In the case of the fourth axis adjustment chip as well, there can be obtained reflected light from the bottom face of the recesses having different surface areas, and from the surface of the protrusion at the center, at one location. When a calibration curve is to be created, therefore, it suffices to perform registration once, which makes the curve creation process simpler. The surface of the protrusion at the center is flat at the atomic level, and hence measurements can be performed with high precision at the protrusion.

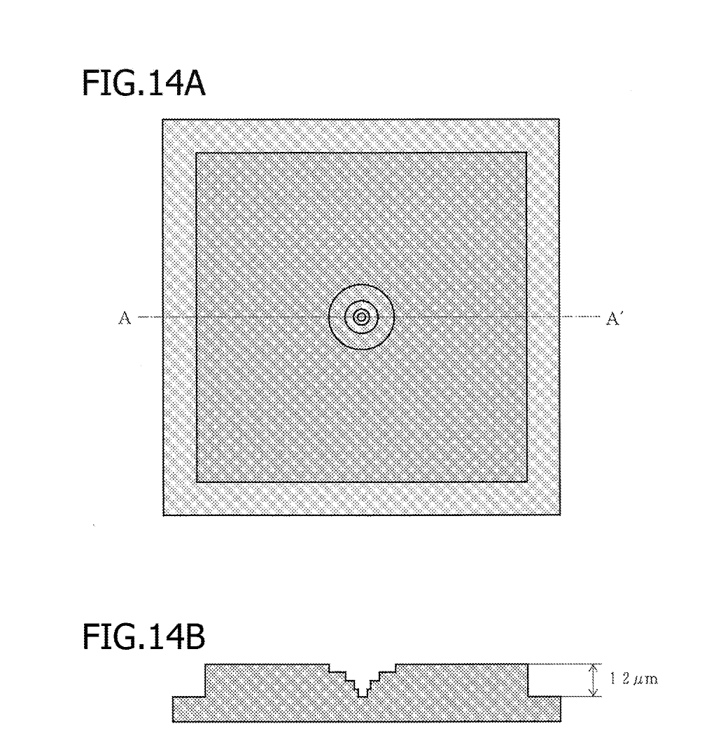

A fifth axis adjustment chip will be explained next with reference to FIGS. 14A and 14B. FIGS. 14A and 14B is a set of explanatory diagrams of a fifth axis adjustment chip that is used in the measurement method using optical interferometry of Embodiment 4 of the present invention, where FIG. 14A is a plan-view diagram and FIG. 14B is a cross-sectional diagram in which there are connected the horizontal portions of the dashed line that joins A-A′ in FIG. 14A. The fifth axis adjustment chip is fabricated out of a single-crystal Si substrate, to have concentric cylindrical recesses with diameters of 20 μm, 10 μm, 5 μm and 3 μm sequentially delved by a depth of 3 μm. Further, X-direction and Y-direction knife edges are provided around the chip. The fabrication process may involve etching according to a protrusion-recess scheme that is the reverse of that of the third axis adjustment chip.

In the case of the fifth axis adjustment chip as well, there can be obtained reflected light from the bottom face of the recesses having different surface areas, and from the surface of the protrusion at the center, at one location. When a calibration curve is to be created, therefore, it suffices to perform registration once, which makes the curve creation process simpler. In the fourth axis adjustment chip, the 3 μm protrusion at the center is readily damaged for instance in the resist coating process or the like, but the fabrication process of the fifth axis adjustment chip demands no precision, since no protrusion is formed.

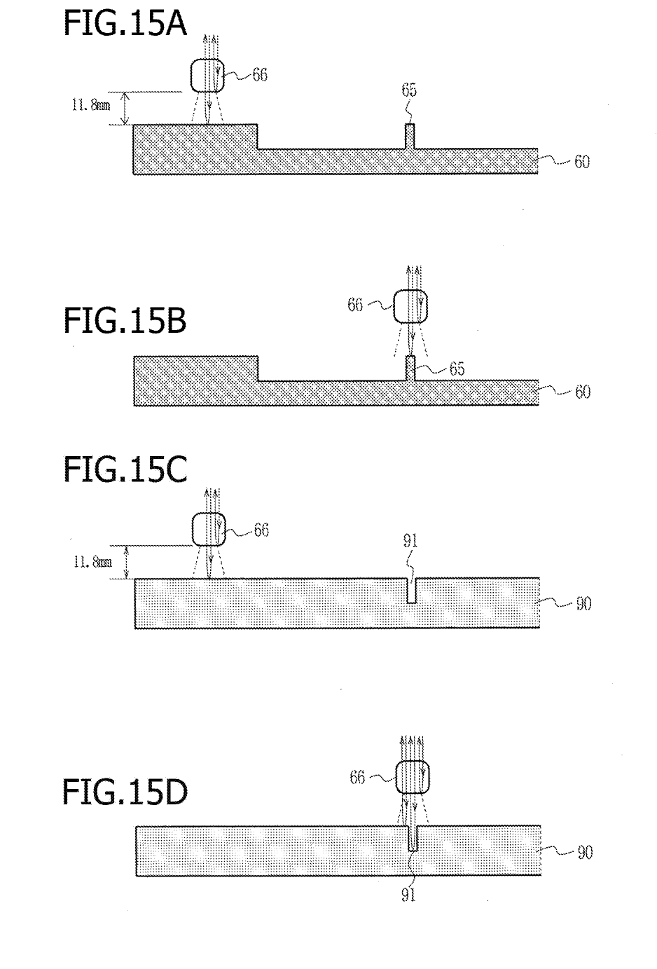

A measurement method using optical interferometry of Embodiment 4 of the present invention will be explained next with reference to FIGS. 15A to 15D. An instance will be explained herein in which there is used the above-described first axis adjustment chip for axis adjustment. An axis adjustment step will be explained first.

ns₁: sample tilt is adjusted, using the optical microscope, in such a manner that the optical microscope comes along the normal line of the surface of a protrusion pattern. To that end, the sample tilt is adjusted, through observation using the optical microscope, so that the side wall of the protrusion is not visible, or so that the surface area of the protrusion top is maximized.
ns₂: As in a conventional method, the offset between the optical axis of the optical microscope and the optical axis of the sensor is adjusted using the protrusion pattern. To that end, the intensity of interference light by reflected light from the protrusion pattern is set to be maximal.
ns₃: The distance between the protrusion pattern and the sensor is adjusted so as to take on a desired value, for instance a specified value of 11.8 mm.
ns₄: The tilt of the sensor is finely adjusted so that the interference light peak intensity by reflected light from the protrusion pattern is maximized.
ns₅: Herein ns₂ to ns₄ are repeated, for narrowing down to a condition where the interference peak is strongest, at a fixed distance from the sensor. The diameter of the probe at this time is preferably larger than the hole diameter that is to be measured.

After axis adjustment has been carried out according to the above steps, the depth of the hole for TSV and hole diameter are measured simultaneously. Firstly, hole diameter is worked out by:

NS₁: measuring interference peak intensity (ref. 1) at a flat portion of height identical to that of a protrusion 65, using the first axis adjustment chip 60, as illustrated in FIG. 15A;
NS₂: next, measuring the intensity (ref. 2) of an interference peak at a protrusion 65 of size similar to that of the hole for TSV that is to be measured, as illustrated in FIG. 15B;
NS₃: calculating an intensity ratio of ref. 2 with respect to ref. 1. Herein the sizes of various protrusions may be measured beforehand, to create a calibration curve on the basis thereof.
NS₄: Next, adjusting the distance from the sensor to a specified value, at a flat portion in the vicinity of a hole for TSV 91 in a Si wafer 90 provided with a hole for TSV 91 that is to be measured, and thereafter, as illustrated in FIG. 15C, measuring interference peak intensity (ref. 3).
NS₅: Next, as illustrated in FIG. 15D, moving a sensor head 66 up to the hole for TSV 91 to be measured, adjusting the distance between the flat portion and the sensor to a specified value, and thereafter, measuring interference peak intensity (ref. 4) from the flat portion.
NS₆: Working out a difference between the intensity of ref. 3 and the intensity of ref. 4, and comparing the result with the result in NS₃, whereby a hole diameter is determined.
NS₇: The depth of the hole for SV 91 can be grasped herein since the interference peak from the bottom of the hole for TSV 91 is measured at the same time.

An axis adjustment chip is used thus in Embodiment 4 of the present invention. Therefore, axis adjustment is easy, while the depth of a hole for TSV and hole diameter can be measured simultaneously with good precision.

### Embodiment 5

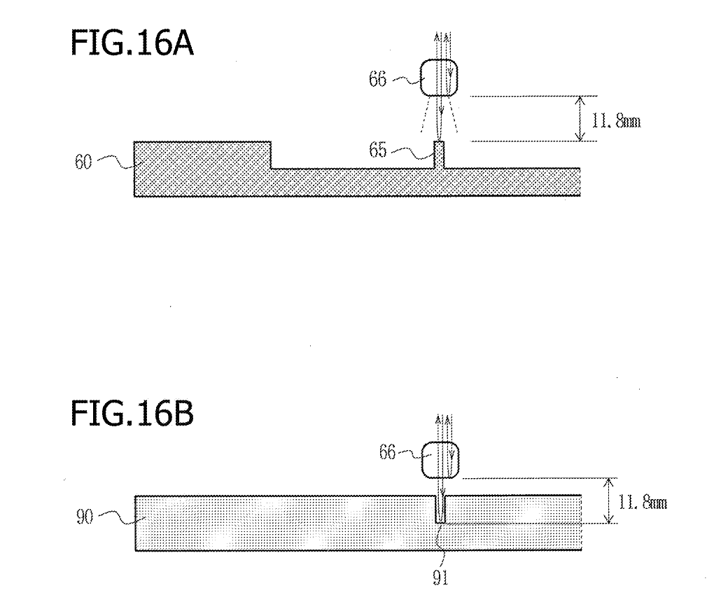

A measurement method using optical interferometry of Embodiment 5 of the present invention will be explained next with reference to FIGS. 16A and 16B. Herein, the diameter of a flat portion at the bottom of a hole for TSV is measured along with the depth of a hole for TSV. Axis adjustment is performed in accordance with the same procedure as that of Embodiment 4, using the first axis adjustment chip described above for axis adjustment.

nS₁: Firstly, there is measured the intensity of the interference peak (Ref. 1) at a protrusion 65 of size similar to that of the hole for TSV that is to be measured, as illustrated in FIG. 16A. Herein the sizes of various protrusions may be measured beforehand, to create a calibration curve on the basis thereof.
nS₂: Next, as illustrated in FIG. 16B, the sensor head 66 is moved to the hole for TSV 91 to be measured, and the distance from the sensor up to the bottom of the hole for TSV 91 is adjusted to a specified value, after which interference peak intensity (Ref. 2) is measured.
nS₃: The percentage by which Ref. 2 is smaller than Ref. 1 is then worked out, to obtain the diameter of the hole for TSV 91. Specifically, the diameter of the flat portion of the bottom portion is ordinarily smaller than the hole diameter at the surface, and hence the diameter of the hole for TSV 91 can be worked out on the basis of an intensity ratio.

An axis adjustment chip is used thus in Embodiment 5 of the present invention. Therefore, axis adjustment is easy, while the diameter of the flat portion of the bottom of the hole for TSV can be measured simultaneously together with the depth of the hole for TSV, with good precision.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A measurement device using optical interferometry, comprising:
a sensor that measures a distance by optical interferometry;
an optical microscope, the optical axis of which is in a predetermined relationship with the optical axis of the sensor;
a sample stage on which a sample to be measured is placed;
a unit that keeps a predetermined distance between a sensor head end of the sensor and a surface of the sample during measurement; and
a tilt adjustment unit that tilts one of the surface of the sample and the optical axis of the sensor so that the intensity of the sensor light from the surface of the sample or the interference intensity of the sensor light reflected from the surface of the sample and the sensor head end exhibits maximized.

2. The measurement device using optical interferometry according to claim 1, wherein at least part of an optical system of the sensor shares an optical system of the optical microscope.

3. The measurement device using optical interferometry according to claim 1, wherein an optical system of the sensor includes an optical system separate from an optical system of the optical microscope, and has a mechanism that stores offset coordinates for observing a same field of view as that of the optical microscope.

4. The measurement device using optical interferometry according to claim 3, wherein
the measurement device has a shared support member that fixes the sensor and the optical microscope while being capable of simultaneously operating to vary a distance from the sample, and the optical microscope has a mechanism that tilts independently only the optical axis; and
the sensor has a driving mechanism that allows adjusting independently the distance between the sample and the tilt adjustment mechanism that tilts independently the optical axis.

5. The measurement device using optical interferometry according to claim 3, wherein
the measurement device has a shared support member that fixes the sensor and the optical microscope while being capable of simultaneously operating to vary a distance from the sample;
the sample stage has a tilt adjustment mechanism that allows adjusting tilt independently, and the sensor has a driving mechanism that allows adjusting independently the distance between the sample and the tilt adjustment mechanism that tilts independently the optical axis.

6. A measurement method using optical interferometry, comprising:
radiating sensor light, from a sensor having an optical axis being in a predetermined relationship with an optical axis of an optical microscope, onto a sample to be measured, in a state where a distance between a sensor head end of the sensor and a surface of the sample is kept constant, while observing, by the optical microscope, the surface of the sample in a state where a predetermined distance to the surface of the sample is kept;
tilting one of the surface of the sample and the optical axis of the sensor so that the intensity of the sensor light reflected from the surface of the sample or the interference intensity of the sensor light reflected from the surface of the sample and the sensor head end exhibits maximized; and
measuring an interference waveform of reflected light of the sensor light from the sensor head end, in a state where the intensity of the sensor light reflected from the surface of the sample or the interference intensity of the sensor light reflected from the surface of the sample and the sensor head end exhibits maximized, and determining, by optical interferometry, a distance between a portion to be measured in the sample and the sensor head end.

7. The measurement method using optical interferometry according to claim 6, wherein the sample is a semiconductor substrate, and the portion to be measured is a via hole for a through-via provided in the semiconductor substrate.

8. The measurement method using optical interferometry according to claim 7, wherein a probe diameter of the sensor light is equal to or smaller than ¾ of a via diameter of the via hole.

9. The measurement method using optical interferometry according to claim 7, comprising simultaneously radiating the sensor light onto the via hole and a flat surface of the sample in which the via hole is not provided.

10. The measurement method using optical interferometry according to claim 7, comprising:
obtaining a power spectrum through Fourier transformation of the measured interference waveform; and
cross-comparing and analyzing intensity and shape of the power spectrum, to calculate thereby a degree of flatness of a bottom face of the via hole or surface roughness of the surface of the sample in the vicinity of the via hole

11. The measurement method according to claim 6, comprising: prior to measurement, adjusting an optical axis adjustment of the optical microscope and of the sensor, using an axis adjustment dedicated member that has an axis adjustment structure including a protrusion or a recess having a planar area that is within a range of ±10% of the planar area of the portion to be measured.

12. The formation side method according to claim 11, wherein the axis adjustment dedicated member has a plurality of protrusions of dissimilar planar areas.

13. The formation side method according to claim 11, wherein the axis adjustment dedicated member has a plurality of recesses of dissimilar planar areas and having an aspect ratio equal to or smaller than 1.

14. The measurement method according to claim 11, wherein the axis adjustment dedicated member has a stepped protrusion in which concentric cylindrical protrusions are superposed in decreasing order of size.

15. The measurement method according to claim 11, wherein the axis adjustment dedicated member has a stepped recess in which concentric cylindrical recesses are delved in decreasing order of size.

16. The measurement method according to claim 11, wherein the axis adjustment dedicated member has a stepped recess, in which concentric cylindrical recesses are delved in decreasing order of size, and a protrusion provided at the center of the stepped recess.

17. The measurement method according to claim 11, wherein
in the adjusting of optical axis adjustment,
the axis adjustment dedicated structure is a protrusion, and the adjustment includes:
adjusting the tilt of the sample or the optical microscope so that a state is brought about in which a side wall of the protrusion is not visible, or a surface area of the protrusion is maximized; and
in a state where a distance up to the surface of the protrusion has been set to a specified value, adjusting the optical axis of the sensor in such a manner that an interference peak is maximized, and finely adjusting an amount of offset with respect to the optical microscope.

18. The measurement method according to claim 11, wherein
in the adjusting of optical axis adjustment,
the axis adjustment dedicated structure is a recess, and the adjusting includes:
adjusting the tilt of the sample or the optical microscope so that a state is brought about in which a side wall of the recess is not visible, or a surface area of the recess is maximized; and
in a state where a distance up to the surface of the recess has been set to a specified value, adjusting the optical axis of the sensor in such a manner that an interference peak is maximized, and finely adjusting an amount of offset with respect to the optical microscope.

19. The measurement method according to claim 11, wherein
the portion to be measured is a hole portion, and the method includes:
measuring an interference spectrum intensity at a flat portion of the axis adjustment dedicated member, in a state where a distance between the flat portion and the sensor has been set to a specified value;
measuring an interference spectrum intensity using a protrusion that is provided in the axis adjustment dedicated member and that has a size close to that of the diameter of the hole portion of the portion to be measured; and
measuring the flat portion and the hole portion of the sample thereby measuring thereby a hole diameter of the hole portion.

20. The measurement method according to claim 11, wherein
the portion to be measured is a hole portion, and the method includes:
using a protrusion that is provided in the axis adjustment dedicated member to set a distance between the sensor and the protrusion to a specified value;
measuring an interference spectrum intensity from the protrusion;
setting a distance up to a bottom of the hole portion of the sample to the specified value;
measuring an interference spectrum intensity from the hole portion; and
comparing the interference spectrum intensity from the hole portion and the interference spectrum intensity from the protrusion thereby measuring the surface area of the flat portion of the bottom of the hole portion.
